(19) United States
(12) Patent Application Publication
(10) Pub. No.: US 2015/0186541 A1
(43) Pub. Date: Jul. 2, 2015

(54) NFC PRODUCT IDENTIFICATION AND ORDER REQUEST REDIRECTION

(71) Applicant: NXP B.V., Eindhoven (NL)

(72) Inventor: Victor VEGA, Sunnyvale, CA (US)

(73) Assignee: NXP B.V., Eindhoven (NL)

(21) Appl. No.: 14/145,299

(22) Filed: Dec. 31, 2013

(51) Int. Cl. G06F 17/30; G06Q 30/06

(52) U.S. Cl. CPC G06F 17/30887; G06Q 30/0633

(57) ABSTRACT

Various exemplary embodiments relate to a product assembly including: a product; and a code tag that carries a uniform resource identifier (URI) that includes an identifier for the product, wherein the code tag is configured to be read by a user device to read the URI, wherein the URI points to a lead distribution server and is configured to cause the lead distribution server to redirect the user device to a web page. Various embodiments relate to a method and related user device including: reading information from a code tag associated with a product, wherein the information includes a URI, wherein the URI points to a server and includes an identification of the product; transmitting an access request to the server based on the URI; and communicating, in response to transmitting the access request, with a device to place an order.

### TECHNICAL FIELD

Various exemplary embodiments disclosed herein relate generally to consumer products and services, more particularly but not exclusively, to identifier extraction using near field communication (NFC), radio frequency identification (RFID), optical, and other technologies and a web server or other server for directing consumer requests to participating websites or other servers.

### BACKGROUND

The ever-increasing connectedness provided by the Internet, smart phones, and other emerging technologies has helped online retailers grow from a novelty to a major channel of distribution for many products and services. Online retailers now offer significant competition in the marketplace, to the point where many traditional “brick-and-mortar” retailers are struggling to retain a significant market share. While these traditional retailers often maintain a web presence, the use of popular search engines to locate a retailer to supply a desired product tends to drive a large portion leads only to those most popular online retailers. Search engines also often provide sponsored links, enabling smaller or less popular retailers to have their site listed near the top of search results, but this strategy for driving leads hinges on the consumer deciding to click the sponsored search result instead of deliberately selecting a non-sponsored link or a preferred retailer.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various embodiments described herein relate to a consumer product assembly configured to facilitate ordering of a product, the consumer product assembly including: a consumer product to be used by a consumer; and a code tag that carries a uniform resource identifier (URI) that further includes an identifier for the consumer product, wherein the code tag is configured to be read by user device to read the URI and subsequently send a request to a device associated with the URI, and wherein the URI points to a lead distribution server and is configured to cause the lead distribution server to redirect the user device to a sponsor web page hosted by a device other than the lead distribution server. Various embodiments are described wherein the sponsor web page is configured to receive from the consumer an order for a replacement for the consumer product.

Various embodiments described herein relate to a method performed by a user device for placing an order for a replacement product, the method including: reading, by a user device, information from a code tag associated with a product; wherein the information read from the code tag includes a uniform resource identifier (URI), wherein the URI points to a server and further includes an identification of the product; transmitting an access request to the server based on the URI; and communicating, in response to transmitting the access request, with a device to place an order for a replacement for the product, wherein the device includes at least one of the server and an additional server.

Various embodiments described herein relate to a device for placing an order for a replacement product, the device including: a code tag reader configured to read information from a code tag associated with a product; a network interface for communicating via a network; and a processor configured to: receive the information read from the code tag, wherein the information includes a uniform resource identifier (URI), wherein the URI points to a server and further includes an identification of the product, transmit, via the network interface, an access request to the server based on the URI, and communicate, via the network interface in response to transmitting the access request, with a device to place an order for a replacement for the product, wherein the device includes at least one of the server and an additional server.

Various embodiments described herein relate to a non-transitory machine-readable storage medium encoded with instructions for execution by a user device for placing an order for a replacement product, the medium including: instructions for reading, by a user device, information from a code tag associated with a product; wherein the information read from the code tag includes a uniform resource identifier (URI), wherein the URI points to a server and further includes an identification of the product; instructions for transmitting an access request to the server based on the URI; and instructions for communicating, in response to transmitting the access request, with a device to place an order for a replacement for the product, wherein the device includes at least one of the server and an additional server.

Various embodiments are described wherein the code tag is attached to the consumer product.

Various embodiments are described wherein the code tag is a near field communication (NFC) tag.

Various embodiments are described wherein the code tag further stores an instruction to access the URI.

Various embodiments are described wherein the consumer product includes: a consumable portion; and a non-consumable portion, wherein the replacement for the consumer product includes a replacement consumable portion.

Various embodiments are described wherein: the code tag is affixed to the consumable portion; and the non-consumable portion is configured to modify the URI stored by the code tag.

Various embodiments are described wherein communicating, in response to transmitting the access request, with a device to place an order for a replacement of the product, wherein the device includes at least one of the server and an additional server includes: receiving, from the device, data for rendering a web page, wherein the web page may be used to place an order for a replacement of the product.

Various embodiments are described wherein the server is a lead distribution server and communicating, in response to transmitting the access request, with a device to place an order for a replacement of the product, wherein the device includes at least one of the server and an additional server includes: receiving, from the lead distribution server in response to transmitting the access request, an instruction to access an additional URI that points to a sponsor web server; and transmitting an additional access request to the sponsor web server based on the additional URI.

Various embodiments are described wherein transmitting the additional access request results in ordering the replacement for the product absent subsequent operation of the device by the user.

Various embodiments additionally include modifying at least one of the access request and the additional access request to carry payment information.

Various embodiments additionally include prior to transmitting the additional access request: reading the payment information from an additional code tag associated with a payment instrument.

Various embodiments additionally include modifying the access request to carry at least one of information regarding a user of the product and information regarding recorded use of the product.

Various embodiments are described wherein: the product includes a consumable portion and a non-consumable portion, the replacement for the product includes a replacement for the consumable portion, and the method further includes, prior to modifying the access request to carry at least one of information regarding a user of the product and information regarding recorded use of the product, communicating with the non-consumable portion to obtain the at least one of information regarding a user of the product and information regarding recorded use of the product.

Various embodiments described herein relate to a method performed by a user device for placing an order, the method including: reading, by a user device, information from a code tag, wherein the information read from the code tag includes a uniform resource identifier (URI), and wherein the URI points to a server and further includes an identifier; transmitting an access request to the server based on the URI; and communicating, in response to transmitting the access request, with a device to place an order for at least one of a product and a service, wherein the device includes at least one of the server and an additional server.

Various embodiments described herein relate to a device for placing an order, the device including: a code tag reader configured to read information from a code tag associated with a product; a network interface for communicating via a network; and a processor configured to: read, via the code tag reader, information from a code tag, wherein the information read from the code tag includes a uniform resource identifier (URI), and wherein the URI points to a server and further includes an identifier; transmit, via the network interface, an access request to the server based on the URI; and communicate, in response to transmitting the access request, with a device to place an order for at least one of a product and a service, wherein the device includes at least one of the server and an additional server.

Various embodiments described herein relate to a non-transitory machine-readable storage medium encoded with instructions for execution by a user device for placing an order, the medium including: instructions for reading, by a user device, information from a code tag, wherein the information read from the code tag includes a uniform resource identifier (URI), and wherein the URI points to a server and further includes an identifier; instructions for transmitting an access request to the server based on the URI; and instructions for communicating, in response to transmitting the access request, with a device to place an order for at least one of a product and a service, wherein the device includes at least one of the server and an additional server.

Various embodiments are described wherein the code tag is affixed to a product and the order is placed for a service associated with the product.

Various embodiments are described wherein the service is a repair of the product.

Various embodiments are described wherein the code tag is affixed to an advertisement for the at least one of the product and the service.

Various embodiments described herein relate to a lead distribution server for facilitating placement of an order, the lead distribution server including: a network interface configured to communicate with a user device; a storage device configured to store a plurality of sponsor rules; and a processor configured to: receive a request from the user device, wherein the request includes an identifier, locate a sponsor rule of the plurality of sponsor rules, wherein the sponsor rule is associated with the identifier and identifies a plurality of sponsors, select a sponsor of the plurality of sponsors, and facilitate placement of an order with the selected sponsor.

Various embodiments described herein relate to a method performed by a lead distribution server for facilitating placement of an order, the method including receiving a request from the user device, wherein the request includes an identifier, locating a sponsor rule of a plurality of sponsor rules, wherein the sponsor rule is associated with the identifier and identifies a plurality of sponsors, selecting a sponsor of the plurality of sponsors, and facilitating placement of an order with the selected sponsor.

Various embodiments described herein relate to a non-transitory machine-readable storage medium encoded with instructions for execution by a lead distribution server for facilitating placement of an order, the medium including instructions for receiving a request from the user device, wherein the request includes an identifier, instructions for locating a sponsor rule of a plurality of sponsor rules, wherein the sponsor rule is associated with the identifier and identifies a plurality of sponsors, instructions for selecting a sponsor of the plurality of sponsors, and instructions for facilitating placement of an order with the selected sponsor.

Various embodiments are described wherein: the sponsor rule further stores a plurality of weights respectively associated with the plurality of sponsors, and in selecting the sponsor, the processor is configured to perform a selection based on the plurality of weights.

Various embodiments are described wherein, in facilitating placement of the order, the processor is configured to send a redirection instruction to the user device via the network interface, wherein the redirection instruction includes a uniform resource identifier (URI) associated with the selected sponsor.

Various embodiments are described wherein, in facilitating placement of the order, the processor is configured to communicate via the network interface with a device associated with the selected sponsor to place the order.

Various embodiments are described wherein, the storage further stores user information associated with a user of the user device and in communicating via the network interface with a device associated with the selected sponsor to place the order, the processor is configured to: retrieve the user information from the storage, wherein the user information includes at least one of shipping information and payment information; and transmit the user information to the device associated with the selected sponsor.

Various embodiments are described wherein, in locating the sponsor rule, the processor is configured to: evaluate applicability criteria associated with the rule, and determine, based on the applicability criteria, that the rule is currently applicable.

Various embodiments are described wherein, in facilitating placement of the order, the processor is configured to effect payment by a user of the user device to the selected sponsor.

Various embodiments are described wherein, in effecting payment by a user of the user device to the selected sponsor, the processor is configured to: effect payment of a first amount by the user to an operator of the lead distribution server; and effect payment of a second amount different from the first amount to the selected sponsor.

Various embodiments are described wherein in selecting the sponsor, the processor is configured to select a sponsor based on a price charged by the sponsor for at least one of a product and a service; the second amount is equal to the price; and the first amount is greater than the second amount.

Various embodiments described herein relate to a method for establishing a system for facilitating product orders, the method including: providing a plurality of products with identifier codes; establishing a lead distribution server; enrolling a plurality of sponsors with the lead distribution server in association with the plurality of products; receiving consumer leads including respective ones of the identifier codes from consumers at the lead distribution server; and directing the consumer leads to points of sale of the respective ones of the plurality of sponsors.

Various embodiments are described wherein: enrolling the plurality of sponsors includes associating respective ones of a plurality of weights with the plurality of sponsors; and directing the consumer leads to points of sale of the respective ones of the plurality of sponsors includes selecting sponsors based on the plurality of weights.

Various embodiments are described wherein associating respective ones of a plurality of weights with the plurality of sponsors includes selecting weights for the plurality of sponsors based on respective amounts of advertising fees paid by the respective sponsors.

Various embodiments are described wherein providing a plurality of products with identifier codes includes providing the plurality of products with code tags bearing the respective identifier codes.

Various embodiments are described wherein the code tags bear respective uniform resource identifiers (URIs) that point to the lead distribution server.

Various embodiments are described wherein the points of sale are respective sponsor websites.

Various embodiments are described wherein providing a plurality of products with identifier codes includes providing a single identifier code to each of the plurality of products.

### BRIEF DESCRIPTION OF THE DRAWINGS

In order to better understand various exemplary embodiments, reference is made to the accompanying drawings, wherein:

FIG. 1 illustrates an exemplary system for ordering a product;

FIG. 2 illustrates an exemplary method for establishing and operating a system for ordering a product;

FIG. 3 illustrates an exemplary data arrangement for storing instructions in a code tag;

FIG. 4 illustrates an exemplary component diagram of a user device;

FIG. 5 illustrates an exemplary method for reading a code tag;

FIG. 6 illustrates an exemplary component diagram for a lead distribution server;

FIG. 7 illustrates an exemplary hardware diagram for implementing a user device or a lead distribution server;

FIG. 8 illustrates an exemplary data arrangement for storing a products database;

FIG. 9 illustrates an exemplary sponsor rule; and

FIG. 10 illustrates an exemplary method for redirecting a consumer lead.

To facilitate understanding, identical reference numerals have been used to designate elements having substantially the same or similar structure or substantially the same or similar function.

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or,” as used herein, refers to a non-exclusive or (i.e., and/or), unless otherwise indicated (e.g., “or else” or “or in the alternative”). Additionally, the various embodiments described herein are not necessarily mutually exclusive and may be combined to produce additional embodiments that incorporate the principles described herein.

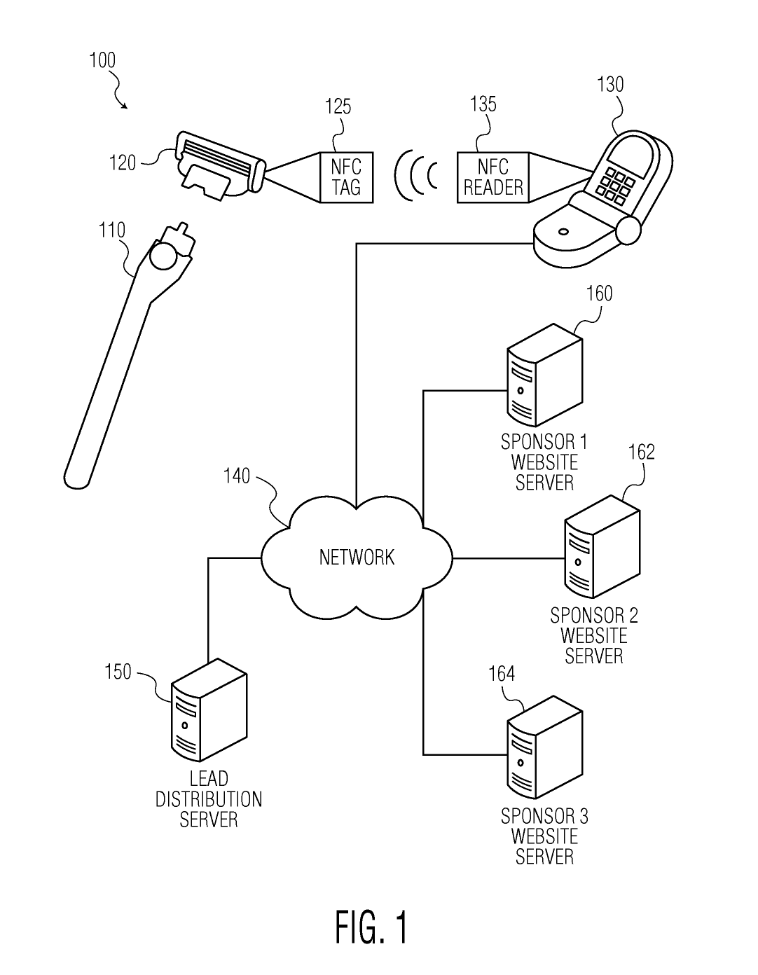

FIG. 1 illustrates an exemplary system 100 for ordering a product. Specifically, the example shown relates to ordering a razor head. As such, the system includes a razor handle 110, razor head 120, and user device 130. It will be understood that the concepts described herein may be applied to additional or alternative consumable products, non-consumable products, or services. Various modifications to the system 100 for enabling such alternative products and services will be apparent.

The razor handle 110 may be a non-consumable product that is used in conjunction with the razor head 120, which may be considered a consumable product. Once a consumer has determined that the razor head 120 has been “consumed” and should be replaced, the razor head 120 may detach from the razor handle 110 for disposal. The razor handle 110 may then be connected to a new razor head (not shown) for continued use. It will be apparent that in various alternative embodiments wherein ordering of a service or product other than a razor head is enabled, the razor handle 110 may not be present.

As shown, a near field communication (NFC) tag 125 is affixed to the razor head 120. As used herein, the term “affixed” will be understood to include any method of connecting the NFC tag (or other code tag) to the razor head 120 (or other base) such as, but not limited to, surface attachment via adhesive or mechanical connection, integral formation of the tag with the base such as by molding the tag within the base, etc. The NFC tag 125 stores ordering information that may be used by a user device for ordering replacement razor heads (not shown). For example, the NFC tag 125 may store a product identifier, instructions that effect an order of replacement razor heads, or a uniform resource identifier (URI) that may be used to access a website where replacement razor heads may be ordered. It will be apparent that various alternative embodiments may employ different arrangements for carrying ordering information. For example, alternatives to an NFC tag may be used such as a different type of code tag or a human readable code. As used herein, the term “code tag” refers to a tag that includes information in a form that is only readable by a device (such as in the case of, but not limited to, NFC, RFID, bar code, and QR code tags) and the term “device” will be understood to exclude human beings. Alternative code tags may include a radio frequency identification (RFID) tag or an optical tag such as a bar code or quick response (QR) code. As another example, the NFC tag 125 (or an alternative) may not be affixed directly to the razor head 120 and, instead, may be otherwise associated with the razor head 120. For example, the NFC tag 120 may be affixed to the razor handle 110, the packaging of either the razor handle 110 or razor head 120, or an insert included with either the razor handle 110 or razor head 120. As used herein, the term “carry” when used with respect to a code tag will refer to any means by which a code tag may maintain information to be read by another device and will therefore be understood to include various means such as, but not limited to, electronically storing information or optically bearing the information in coded or non-coded form. Various other alternatives for implementing the methods described herein will be apparent.

As used herein, the term “replacement” will be understood to encompass both similar model products and different model products that may be used in place of the original product. For example, reading the NFC tag 125 may facilitate ordering of the same model of razor head as of razor head 120 or a different model of razor head from the razor head 120 that will nonetheless attach to the razor handle 110.

In addition to the razor handle 110 and razor head 120, the user may also own or otherwise control a user device 130. The user device 130 may be any device capable of communication via a network 140, such as the Internet or a mobile carrier network. For example, the user device 130 may be a mobile phone, tablet, laptop, personal computer, or standalone device primarily purposed for placing orders via the network 140. To facilitate use of the NFC tag 125, the user device 130 includes an NFC reader 135. In alternative embodiments wherein the NFC tag 125 is replaced by a different type of code tag, the NFC reader 135 will be replaced by a matching code tag reader. Further, in alternative embodiments wherein the NFC tag 125 is replaced by a human readable code, the NFC reader 135 may be replaced by an appropriate hardware and software interface to enable a user to enter the code.

In addition to the devices 110, 120, 130 at the consumer's location, multiple servers may be connected to and accessible via the network 140. As shown, the system may include a lead distribution server 150 and multiple sponsor website servers 160, 162, 164. These servers 150, 160, 162, 164 each include hardware and machine-executable instructions configured receive and process requests sent by the user device 130 via the network. As such, each of the servers 150, 160, 162, 164 may be a laptop, personal computer, server computer, server blade, cloud device, or other hardware device configured to operate as a network server. The lead distribution server 150 may be configured to redirect the user device 130 to an appropriate sponsor server 160, 162, 164 for ordering a replacement razor head or a different model razor head, as will be described in greater detail below. The sponsor website servers 160, 162, 164 may be configured to provide a website for use in ordering products or services. Alternatively or additionally, the sponsor website servers 160, 162, 164 may receive and process requests for orders without user interaction such as in the case of “one click ordering.” It will be apparent that various systems other than the exemplary system 100 illustrated may include fewer or additional of each of the components. For example, thousands of user devices may utilize the system to interact with five distributed lead distribution servers and hundreds of sponsor website servers. In various alternative embodiments, the NFC tag 125 or other code tag may direct the user device 130 directly to one of the sponsor website servers 160, 162, 164 without use of the lead distribution server 150.

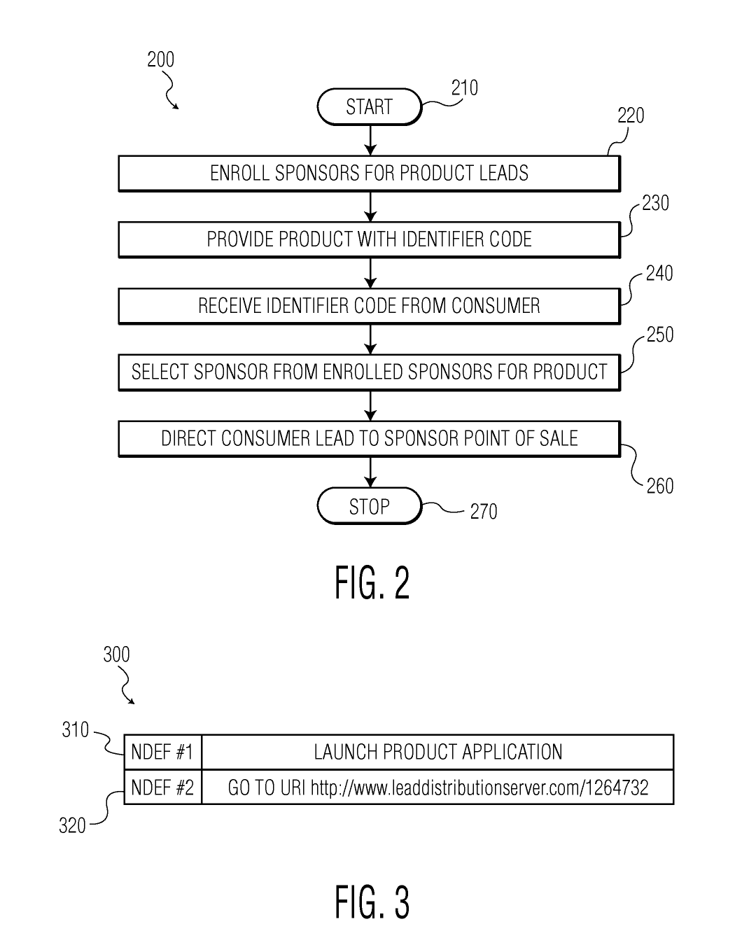

Having described the various components of the exemplary system 100, a high-level example of the operation of the exemplary system 100 will be provided. It will be apparent that the following example is of one embodiment and may also be an abstraction in some respects. Further details related to various implementations will be described in greater detail below with respect to FIGS. 2-10.

Using the exemplary system, the consumer decides that he should order additional razor heads. To begin the ordering process, the consumer places the user device 130 near the razor head 120 and taps to activate the NFC reader 135. The NFC reader 135 reads a URI from the NFC tag 125 and an instruction to access the URI. The URI points to the lead distribution server 150 and carries a product identifier of the razor head 120. As such, in accessing the URI, the user device 130 constructs an HTTP GET message including the URI, and transmits the message to the lead distribution server 150.

It will be understood that various URIs may not alone identify a specific server to access; for example, the URI may utilize a domain name instead of an IP address. In such instances, accessing the resource associated with the URI may involve first accessing a domain name server to resolve the included domain name to an IP address of a server that stores the resource to which the URI points. Accordingly, as used herein, the term “points to” when used with respect to a URI will be understood to refer to both direct (e.g., through specifying IP address) and indirect (e.g., through specifying a domain name) identification of a server.

Upon receiving the message, the lead distribution server 150 extracts the product identifier from the URI and identifies the three sponsor website servers 160, 162, 164 as being enrolled to receive leads for sales of the razor head 120. In this example, each of the sponsors operating the three sponsor website servers 160, 162, 164 have paid advertising fees to the operator of the lead distribution server 150 and are weighted within the lead distribution server 150 according to the amount of advertising fees paid. The lead distribution server 150 utilizes a weighted distribution algorithm and selects sponsor 2 website server 162 to receive the lead. The lead distribution server 150 then sends an HTTP redirect message to the user device, directing the device to a new URI for a webpage hosted by the sponsor 2 website server 162 that can be used to order replacements for the razor head 120. Finally, the consumer of the user device 130 interacts with the website to place the order. Thus, from the point of the consumer, the consumer may reorder by tapping the user device 130 near the razor head 120 and then using the resulting website to order the product. Alternatively or additionally, the consumer may reorder by tapping the user device 130 near the razor handle 110, which may be configured to emulate the code tag or provide additional information such as, for example, usage information. As another alternative, the user device 130 may communicate with the razor handle 110 or razor head 120 without user intervention, such as for example via a Bluetooth connection, to determine when goods or services should be ordered.

Various embodiments may make additional use of the NFC tag 125. For example, in some embodiments, the NFC tag 125 may interface with a management application on the user device 130. The management application may perform various functions such as, for example, tracking the consumer's use of the product, storing user preferences, or enabling one-tap or automatic reordering of the product. Additionally or alternatively, the non-consumable portion of the product 110 may include hardware (not shown) for interfacing with the NFC tag 125. For example, the non-consumable portion 110 may maintain a counter, either onboard or on the NFC tag, for determining how many times the consumable 120 has been used. This counter may be used, for example, by an application on the user device, to determine when the consumable should be replaced. In various embodiments, the non-consumable portion 110 may also modify the NFC tag 125. For example, the non-consumable portion 110 may append values to the end of the URI describing recorded use or user settings associated with operation of the product 110, 120.

FIG. 2 illustrates an exemplary method 200 for establishing and operating a system for ordering a product. The method 200 may be performed by various devices such as a lead distribution server such as the lead distribution server 150 of the exemplary system 100. It will be apparent that the method 200 may be a simplification in some respects and that various steps may be performed in different orders or in parallel with other steps.

The exemplary method 200 begins in step 210 and proceeds to step 220 where the lead distribution server enrolls sponsors for product leads. For example, the lead distribution server may associate various sponsors in a database with various products offered by the sponsors and for which lead generation will be enabled. Next, in step 230, the lead distribution server or another device may provide one or more products with an identifier code. For example, a device may encode one or more NFC tags with a URI pointing to the lead distribution server and identifying the product. As one alternative, a device may generate a bar code bearing a UPC. Various other alternatives will be apparent in view of the below description. Additionally, in step 230, the lead distribution server may record an association between the identifier code and the product or sponsors enrolled for the product.

In step 240, the lead distribution server may receive an identifier code from a consumer. For example, a user device, having read a provided NFC tag, may have transmitted a request for a resource at a URI that identifies the product. In step 250, the lead distribution server may select one sponsor from the sponsors enrolled for the product in step 220. The lead distribution server may use virtually any selection method such as, for example, round robin, weighted round robin, random selection, weighted random selection, static selection of the greatest weight sponsor, lowest price (e.g., when acting as a broker), etc. Then, in step 260, the lead distribution server may direct the consumer lead to a sponsor point of sale such as, for example, by redirecting a user device to the a website of the selected sponsor. The method may then proceed to end in step 270.

FIG. 3 illustrates an exemplary data arrangement 300 for storing instructions in a code tag. For example, the data arrangement 300 may be stored in the NFC tag 125 of the exemplary system. As shown, the data arrangement 300 stores a sequence of NFC data exchange format (NDEF) values and, as such, may apply specifically to embodiments wherein the code tag is an NFC tag. However, various modifications for accomplishing the functionality described for other embodiments, including translation of the described NDEF parameters to exchange formats or other protocols usable with the selected alternative to NFC, will be apparent. In other embodiments wherein the selected code tag or other product identifier does not specifically instruct a user device in how to reorder, such as in some embodiments using a bar code, the data arrangement may simply store an identifier that is understandable and usable by a special purpose application running on the user device.

As shown, the exemplary data arrangement 300 includes two NDEF entries 310, 320. The first NDEF entry 310 indicates that the reading device should launch a specific application associated with the product being tapped. For example, in the exemplary system 100 of FIG. 1, the first NDEF entry 310 may instruct the user device to launch an application associated with the razor 110, 120. The application may perform various functions such as product configuration or reorder facilitation in accordance with pre-configured user preferences. In some embodiments, a product application may not be provided for a particular product and, as such, the NDEF entry 310 may be omitted and the second NDEF entry 320 may be the first NDEF entry in order.

The second NDEF entry 320 may be configured to execute when execution of the first NDEF entry 310 fails or when the user device is tapped a second time (or, in embodiments wherein the first NDEF entry is omitted, automatically upon tapping). As shown, the second NDEF entry 320 includes an instruction to access a URI “http://www.leaddistributionserver.com/1264732.” This URI may resolve to an IP address associated with a lead distribution server and, as such, may prompt a user device to transmit a message to the lead distribution server. The URI also includes an identifier “1264732” associated with the attached product. In the example system 100, the identifier may identify a model of the razor head 120. It will be apparent that other methods of carrying a product identifier may be used. For example, instead of including the identifier in the hierarchical part of the URI, the product identifier may be included as part of the query string of the URI such as, for example, “http://www.leaddistributionserver.com/redirect?product_id=1264732.” In other embodiments, the product id may not be included in the URI itself and, instead, may be carried elsewhere in the message, such as a payload. In embodiments wherein NDEF 320 is executed based on a failure of NDEF 310 execution, access of the specified URI may also initiate download of a product application onto the user device. Further, in some embodiments, the URI may not point to a lead distribution server and, instead, may point directly to a sponsor page where the product replacement may be reordered without any URL redirection. It will be apparent that the data arrangement 300 may include additional entries (not shown).

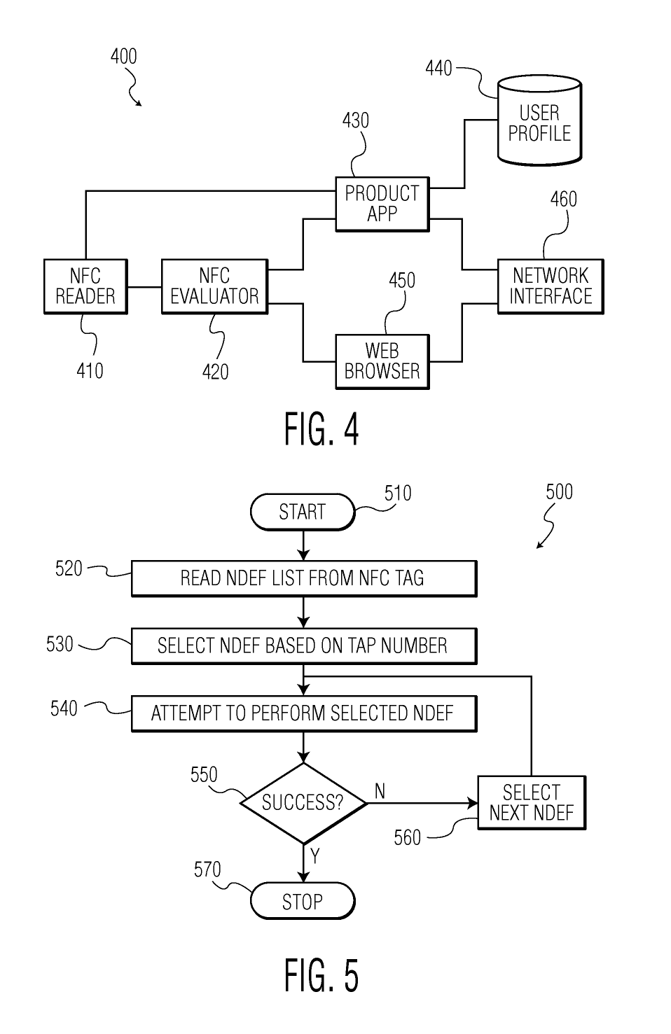

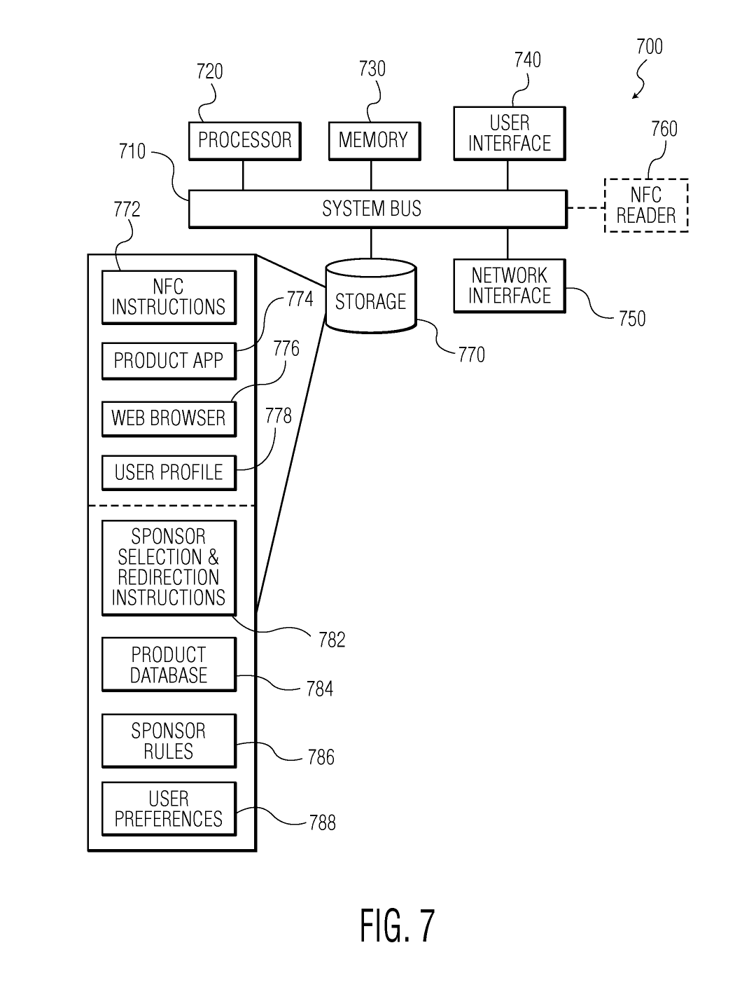

FIG. 4 illustrates an exemplary component diagram 400 of a user device. The user device 400 may correspond to the user device 130 of the exemplary system 100. The user device 400 may be in some respects an abstraction; it will be understood that the various components of the user device 400 may be implemented by hardware devices. Exemplary hardware for supporting the components of the user device 400 will be described in greater detail below with respect to FIG. 7.

The exemplary user device 400 includes an NFC reader 410 for communicating with one or more NFC tags. The NFC reader 410 includes hardware and software configured to communicate according to the NFC protocol. It will be apparent that in embodiments using an alternative to NFC, an alternative device may be included in place (or in addition to) the NFC reader 410 such as, for example, an RFID reader or camera for optical codes. Upon reading data from an NFC tag, the NFC reader 410 passes the data to an NDEF evaluator 420.

The NDEF evaluator 420 includes hardware and software configured to implement the NDEF format and carry out instructions so received. Accordingly, based on data read by the NFC reader 410, the NDEF evaluator 420 selects an appropriate NDEF entry and invokes an instructed function. For example, on processing NDEF 310, the NDEF evaluator 420 invokes a product application 430 and may pass additional data (not shown) carried by the NDEF entry 310 to the product application 430, such as a product identifier. As another example, on processing NDEF 320, the NDEF evaluator 420 invokes a web browser 450 and passes the URI for access. Additional actions for the NDEF evaluator 420 in evaluating NDEF instructions will be apparent.

The product application 430 may include software and supporting hardware configured to perform various functions associated with a product. For example, the product application 430 may enable a user to transmit parameters via the NFC reader or other interface to configure operation of a product such as, in the case of a powered razor, the speed at which the motor will operate. The configurations available will vary based on the product being configured.

In various embodiments, the product application 430 may be used to effect transmission of a reorder request via a network interface 460. For example, where a bar code or QR code is used to identify the product, the product application may be configured to utilize a camera or other scanner (not shown) of the user device to capture and decode the code tag, construct a request message including the product identifier, and transmit the message.

In some embodiments, the product application may be used to provide increased functionality or flexibility beyond that available via a simple URI access. For example, the product application 430 may receive a URI from an NFC tag and append additional information to the URI such as, for example, use information or user preferences retrieved from a user profile storage 440. As another example, the product application 430 may enable one-tap, two-tap, or automatic product ordering. To facilitate one-tap ordering, the user profile storage 440 may store payment information for use in placing an order. The payment information may include information relating to a payment instrument, such as credit card or bank account information, or information related to a remote account where payment instrument information is already known, such as login credentials for one or more sponsor websites or the lead distribution server. In some embodiments, the user profile storage 440 may also store one or more preferred sponsors previously identified by the consumer, in which case the product application may select a preferred sponsor in a manner similar to that described herein with respect to a lead distribution server and generate a request message according to the selected sponsor's one-click application programmer interface (API) to effect ordering of the product. Alternatively, the product application may communicate with the lead distribution server, which may redirect the user device 300 to a sponsor according to the sponsor's one-click application programmer interface (API) to effect ordering of the product. Various other methods for enabling one-tap ordering will be apparent.

To facilitate two tap ordering, the product application 430 may be configured to communicate with a product NFC tag or alternative as described above and to additionally communicate with a payment instrument of the consumer. For example, the user may tap a razor head and then an NFC-enabled credit card. The product application 430 may then use the information retrieved from these two sources to place an order in a manner similar to that described above with respect to one-tap ordering. Various other methods to facilitate two-tap ordering will be apparent.

It will be apparent that the terms “one tap” and “two tap” order does not imply that multiple taps may not be used to facilitate one-tap ordering. For example, to reduce the likelihood of accidental ordering, one-tap ordering may be invoked upon the consumer tapping the user device to the product multiple times in quick succession. Configurations for enabling such functionality will be apparent in view of the foregoing.

To facilitate automatic reordering, the product application 430 may be configured to accept a stimulus other than a tap against a code tag to trigger ordering of a product in a manner similar to that described above with respect to one-tap ordering. For example, the consumer may preconfigure the product application 430 to periodically reorder a product by tapping the product to the user device and then entering a schedule for ordering items associated with the read product identifier. As another example, the product application may communicate with a non-consumable portion of the product and determine that a counter showing number of recorded uses of the consumable portion has exceeded a threshold or may communicate with multiple nearby consumable portions and determine that the number of available consumable portions has fallen below an acceptable threshold. Various additional or alternative stimuli for triggering an automatic reorder will be apparent.

The product application 430 may also facilitate consumer configuration of the user profile storage 440. For example, the consumer may be able to use the product application to enter payment information, sponsor preferences, other preferences, and any other information that may be stored in the user profile storage. The user profile storage 440 may be any machine-readable medium capable of storing such profile information. Accordingly, the user profile storage 440 may include a machine-readable storage medium such as read-only memory (ROM), random-access memory (RAM), magnetic disk storage media, optical storage media, flash-memory devices, and/or similar storage media.

The web browser 450 may include software and supporting hardware configured to enable web navigation. As such, the web browser 450 implements various protocols such as HTTP and is configured to render HTML for display. Upon receiving a URI from the NDEF evaluator 420, the web browser 450 generates an HTTP Get message and transmits the message to the specified device via the network interface 460. Upon receiving an HTTP redirect via the network interface 460, the web browser may transmit an additional HTTP GET message to the URI specified by the received redirect. The web browser 450 may also receive user input for communicating with a sponsor server. For example, the web browser 450 may enable a user to fill out and submit a web form. Various other functionality for the web browser 450 will be apparent.

The network interface 460 may include one or more devices for enabling communication with other hardware devices. For example, the network interface 460 may include a cellular antennae configured to communicate according to a 3G or 4G network protocol or a network interface card (NIC) configured to communicate according to the Ethernet protocol. Additionally, the network interface 460 may implement a TCP/IP stack for communication according to the TCP/IP protocols. Various alternative or additional hardware or configurations for the network interface 460 will be apparent.

FIG. 5 illustrates an exemplary method 500 for reading a code tag. The method 500 may be performed by a user device and may be specific to reading NFC tags. Various modifications for enabling the reading of instructions from other code tags will be apparent.

The exemplary method 500 begins in step 510 and proceeds to step 520 where the device reads the NDEF list from a tapped NFC tag. Then, in step 530, the device selects a starting NDEF entry from the NDEF list based on the number of taps recorded. For example, if one tap has been recorded, NDEF #1 may be selected, while if two taps have been recorded, NDEF #2 may be selected. In step 540, the device attempts to perform any instructions specified in the selected NDEF. In step 550, the device may determine whether execution of the instruction returned a success. If the instruction was not successfully performed, the method 500 proceeds to step 560 where the device selects the next NDEF in order. The method 500 then loops back to step 540 to perform the next NDEF. Once an NDEF is successfully performed, the method 500 ends in step 570.

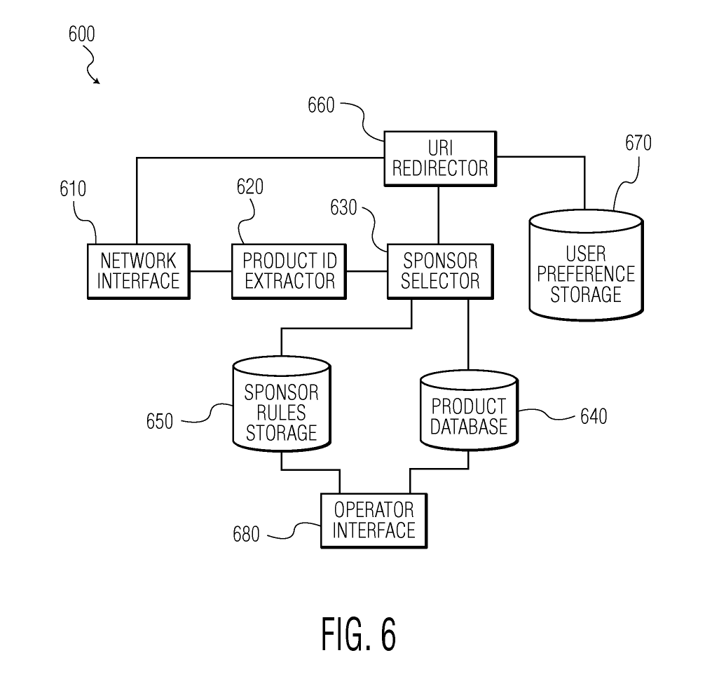

FIG. 6 illustrates an exemplary component diagram 600 for a lead distribution server. The lead distribution server 600 may correspond to the lead distribution server 150 of the exemplary system 100. The lead distribution server 600 may be in some respects an abstraction; it will be understood that the various components of the lead distribution server 600 may be implemented by hardware devices. Exemplary hardware for supporting the components of the lead distribution server 600 will be described in greater detail below with respect to FIG. 7.

The exemplary lead distribution server 600 includes a network interface 610 for communicating with other devices via a network. As such, the network interface 610 may include one or more devices for enabling communication with other hardware devices. For example, the network interface 610 may include a network interface card (NIC) configured to communicate according to the Ethernet protocol. Additionally, the network interface 610 may implement a TCP/IP stack for communication according to the TCP/IP protocols. Various alternative or additional hardware or configurations for the network interface 610 will be apparent.

The exemplary lead distribution server 600 also includes a product ID extractor 620 that includes hardware and software configured to extract a product identifier from a message received via the network interface 610. In some embodiments, such as some embodiments wherein the product identifier is carried as part of a URI requested by the received message, the product ID extractor may include or integrate with a web server of the lead distribution server 600 to provide the product ID extractor 620 with access to the HTTP header, such that the requested URI may be parsed. In other embodiments, the product identifier may be carried in a payload of the message. The product ID extractor 620 passes the extracted product identifier to a sponsor selector 630.

The sponsor selector 630 includes hardware and software configured to select an enrolled sponsor to receive the sales lead associated with the extracted product identifier. Such selection may be performed in any useful manner. In some embodiments, the sponsor selector 630 begins by locating a product record for the extracted product identifier within the product database storage 640. The retrieved record may identify one or more sponsor rules for use in directing the lead. The sponsor selector 630 proceeds by locating the sponsor rules within the sponsor rules storage 650 and identifying an applicable rule from the group. For example, the sponsor selector 650 may locate a sponsor rule that matches the current time of day or a default sponsor rule if no other identified sponsor rules are applicable. Using the applicable sponsor rule, the sponsor selector 650 selects one sponsor from the rule based on the relative weightings assigned within the rule to the sponsors. Then, the sponsor selector 650 retrieves a URI for the selected sponsor from the sponsor rule and passes it to a URI redirector 670.

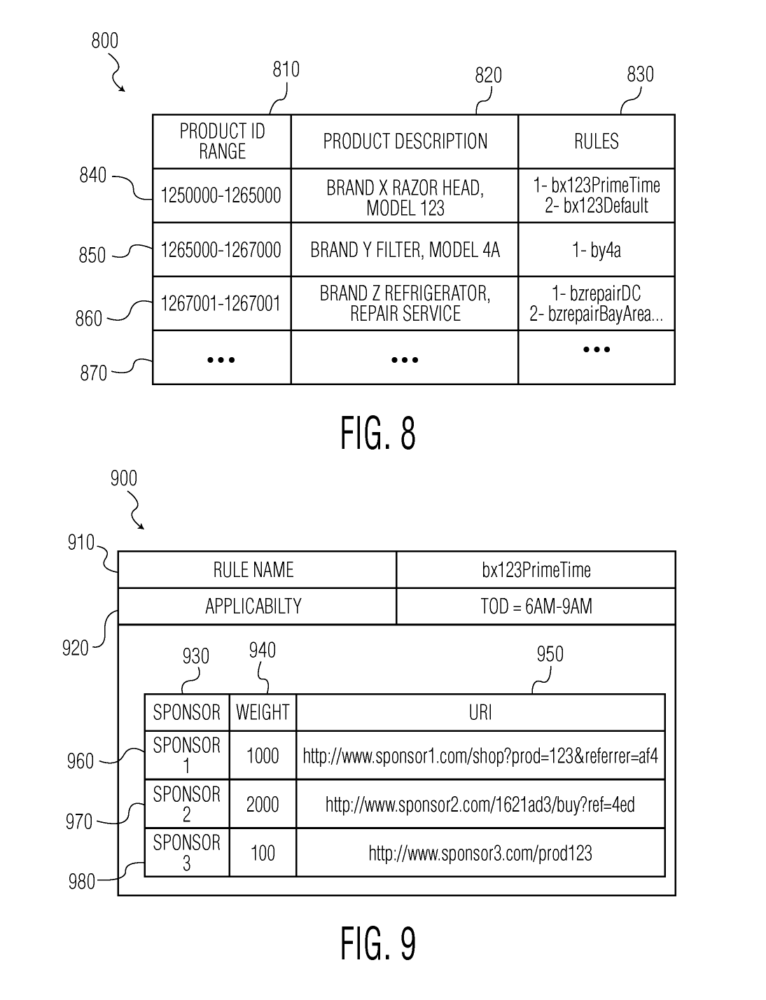

The product database 640 may be any machine-readable medium capable of storing product entries for correlating product identifiers to enrolled sponsors. Accordingly, the product database 640 may include a machine-readable storage medium such as read-only memory (ROM), random-access memory (RAM), magnetic disk storage media, optical storage media, flash-memory devices, and/or similar storage media. Exemplary contents of the product database 640 will be described in greater detail below with respect to FIG. 8.

The sponsor rules storage 650 may be any machine-readable medium capable of storing rules for selecting sponsors such as, for example, sponsor lists, sponsor weights, and URIs for sponsor websites. Accordingly, the sponsor rules storage 650 may include a machine-readable storage medium such as read-only memory (ROM), random-access memory (RAM), magnetic disk storage media, optical storage media, flash-memory devices, and/or similar storage media. Exemplary contents of the sponsor rules storage 650 will be described in greater detail below with respect to FIG. 8. In various embodiments, the sponsor rules storage 650 and product database 640 may share one or more physical storage devices.

The URI redirector 660 includes hardware and software configured to redirect a requesting device to a different URI. For example, upon receiving a URI from the sponsor selector 630, the URI redirector 660 may generate a new HTTP message with a 3XX status code that identifies the URI. The URI redirector 660 may then transmit the message back to the device from which the original HTTP GET message was received. Various alternative methods for redirecting a client device will be apparent. For example, the URI redirector 660 may forward a message directly to the selected sponsor, instructing the sponsor to direct communications to the requesting user device.

In some embodiments, the URI redirector 660 may be further configured to modify the URI prior to redirection. For example, the URI redirector 660 may insert information into the URI that is specific to the user, such as account login information, loyalty program identifiers, captured usage statistics, shipping addresses, etc. Such user information may be previously stored in the user preferences storage 670. As another example, the URI redirector 660 may insert information such as coupon codes into the URI, such that the sponsor server applies a discount to the item being reordered. In other embodiments, the product database 640 or other storage (not shown) may indicate that the user should be upsold or otherwise offered a different product from the requested replacement product. In such embodiments, the URL redirector 660 may generate a web page including a link to the sponsor's URI along with one or more links to other products.

In some embodiments, the lead distribution server 600 may facilitate one-tap, two-tap, or other minimal-interaction ordering. In such embodiments, URIs stored in the sponsor rules storage may be configured to interact with the sponsor web servers' one-click API to effect ordering of the replacement product. Alternatively, the URI redirector 660 may modify the URI provided by the sponsor selector 630 to interface with the sponsor's API. Additionally, the URI redirector 660 may add information, such as account information, payment information, or shipping information to the transmitted message or URI. Such account information, payment information, or shipping information may be previously stored in the user preferences storage 670.

In various embodiments, the lead distribution server 600 may effect order of the replacement product without exposing the consumer to the sponsor that will eventually fulfill the order. In such embodiments, the lead distribution server 600 may charge the user directly for an amount other than the price offered by a selected sponsor and thereby operate in a “broker” mode. For example, the lead distribution server 600 may charge a preset price for the product, an average of the prices provided by all sponsors, or a maximum price offered among all sponsors. As such, the lead distribution server 600 may generate revenue directly from consumers from the difference between the price charged to the consumer and the price charged by the sponsor. Various modifications for effecting such functionality, such as inclusion of a charging system or interface thereto, or implementation of brokerage functionality in a device separate from the lead distribution server (which may simply direct traffic to the separate device according to methods described herein), will be apparent.

The user preferences storage 670 may be any machine-readable medium capable of storing user information. Accordingly, the user preferences storage 670 may include a machine-readable storage medium such as read-only memory (ROM), random-access memory (RAM), magnetic disk storage media, optical storage media, flash-memory devices, and/or similar storage media. In various embodiments, the sponsor rules storage 650, product database 640, or user preferences storage 670 may share one or more physical storage devices.

FIG. 7 illustrates an exemplary hardware diagram 700 for implementing a user device or a lead distribution server. The exemplary device 700 may correspond to the user device 130 or lead distribution server 150 of FIG. 1, user device 400 of FIG. 4, or lead distribution server 600 of FIG. 6. As shown, the device 700 includes a processor 720, memory 730, user interface 740, network interface 750, and storage 770 interconnected via one or more system buses 710. Additionally, the device 700 may include an NFC reader 760, such as in the case where the device 700 implements a user device. It will be understood that FIG. 7 constitutes, in some respects, an abstraction and that the actual organization of the components of the device 700 may be more complex than illustrated.

The processor 720 may be any hardware device capable of executing instructions stored in memory 730 or storage 760. As such, the processor may include a microprocessor, field programmable gate array (FPGA), application-specific integrated circuit (ASIC), or other similar devices.

The memory 730 may include various memories such as, for example L1, L2, or L3 cache or system memory. As such, the memory 730 may include static random access memory (SRAM), dynamic RAM (DRAM), flash memory, read only memory (ROM), or other similar memory devices.

The user interface 740 may include one or more devices for enabling communication with a user such as a consumer or an administrator. For example, the user interface 740 may include a display, a mouse, a touch screen, or a keyboard for receiving user commands.

The network interface 750 may include one or more devices for enabling communication with other hardware devices. For example, the network interface 750 may include a network interface card (NIC) configured to communicate according to the Ethernet protocol. As another example, the network interface 750 may include an antenna for communication via a wireless protocol such as, for example, 3G or 4G cellular networks. Additionally, the network interface 750 may implement a TCP/IP stack for communication according to the TCP/IP protocols. Various alternative or additional hardware or configurations for the network interface 750 will be apparent.

The NFC reader 760 is described above as being present when the device 700 implements a user device, but may also be present when the device 700 implements a lead distribution server. The NFC reader 760 may include hardware adapted to read or otherwise communicate with an NFC tag. It will be apparent that, in embodiments using alternatives to NFC, the NFC reader 760 may be replaced by appropriate hardware for reading a code tag, such as an RFID reader or optical code reader.

The storage 770 may include one or more machine-readable storage media such as read-only memory (ROM), random-access memory (RAM), magnetic disk storage media, optical storage media, flash-memory devices, or similar storage media.

In various embodiments wherein the device 700 implements a user device, the storage 770 may store NFC instructions 772 for reading NFC data and invoking NDEF instructions. In embodiments using alternatives to NFC, the NFC instructions 772 may be replaced by appropriate instructions for driving the reading of a code tag or other identifier acquisition, and invocation of other apps based on such reading. The storage 770 may also store instructions defining a product application 774 and web browser 776, as described above with respect to FIG. 4. The storage 770 may also store a user profile 778.

In various embodiments wherein the device 700 implements a lead distribution server, the storage 770 may store sponsor selection and redirection instructions 782 for receiving a product identifier, selecting a sponsor, and redirecting a consumer to the sponsor website. The storage 770 may also store a product database 784, sponsor rules 786, and user preferences 788 to be used by the selection and redirection instructions 782, as described above with respect to FIG. 6.

It will be apparent that various information described as stored in the storage 770 may be additionally or alternatively stored in the memory 730. In this respect, the memory 730 may also be considered to constitute a “storage device.” Various other arrangements will be apparent. Further, the memory 730 and storage 770 may both be considered to be “non-transitory machine-readable media.” As used herein, the term “non-transitory” will be understood to exclude transitory signals but to include all forms of storage, including both volatile and non-volatile memories.

While the device 700 is shown as including one of each described component, the various components may be duplicated in various embodiments. For example, the processor 720 may include multiple microprocessors that are configured to independently execute the methods described herein or are configured to perform steps or subroutines of the methods described herein such that the multiple processors cooperate to achieve the functionality described herein. In some embodiments, such as those wherein the device 700 is implemented in a cloud computing architecture, components may be physically distributed among different devices. For example, the processor 720 may include a first microprocessor in a first data center and a second microprocessor in a second data center. Various other arrangements will be apparent.

FIG. 8 illustrates an exemplary data arrangement 800 for storing a products database. As such, the data arrangement 800 may reflect the contents of the products database 640 of the exemplary lead distribution server 600. It will be apparent that the data arrangement 800 may be an abstraction and may be stored in any manner known to those of skill in the art such as, for example, a table, linked list, array, database, or other structure. In some embodiments, the data arrangement 800 may be accessible using a query language such as, for example, the structured query language (SQL).

The exemplary data arrangement 800 includes a product ID range field 810, a product description field 820, and a rules field 830. The product ID range field 810 may store an identification of one or more product IDs to which a product record applies. The product ID may be a unique identifier, such as an EPC, GTIN (Global Trade Identification Number), SGTIN (Serial Global Trade Identification Number), or serial number, or a non-unique identifier, such as an SKU, UPC, or model number. Various other product identifiers will be apparent. The product description field 820 may store a human-readable description of the product. The rules field 830 may store an ordered list of rules that are potentially to be used for a product in determining to what sponsor a lead should be directed.

As an example, product record 840 shows that a product ID falling within the range “125000-1265000” is associated with a product “Brand X Razor Head, Model 123.” The product record 840 also indicates that for such a product, the rule “bx123PrimeTime” should first be checked for applicability and, if not applicable, the rule “bx123Default” should be used. These names may refer to separate rules stored and managed by a lead distribution server. An exemplary rule will be described in greater detail below with respect to FIG. 9.

As another example, product record 850 indicates that a product ID falling in the range of “1265000-1267000” is associated with a product “Brand Y Filter, Model 4A.” Additionally, a single rule, “by4a” is defined to handle all requests associated with such a product ID.

As noted above, the system described herein may additionally be used to order services instead of products. For example, the system and concepts described herein may be used to order a taxi service or appliance repair service by tapping on or otherwise reading a code tag. In the example of appliance repair, the code tag may be placed on the appliance for use when repair is needed. As an example of a service “product” record, product record 860 indicates that the product ID “1267001” corresponds to “Brand Z Refrigerator, Repair Service.” Multiple rules applicable to different geographical areas may be associated with this record such as rules “bzrepairDC” and “bzrepairBayArea.” The data arrangement 800 may include numerous additional product records 870.

FIG. 9 illustrates an exemplary sponsor rule 900. As such, the sponsor rule 900 may reflect contents of the sponsor rules storage 650 of the exemplary lead distribution server 600. It will be apparent that the sponsor rule 900 may be an abstraction and may be stored in any manner known to those of skill in the art such as, for example, a table, linked list, array, database, or other structure.

As shown, the sponsor rule 900 includes a rule name 910 “bx123PrimeTime.” As such, the lead distribution server may evaluate this rule when the product record 840 is deemed applicable to a received product ID. The sponsor rule 900 also includes applicability criteria 920 specifying one or more criteria for determining whether the rule 900 should be used for redirecting a lead. Where the sponsor rule 900 is a default rule, the applicability criteria 920 may be absent or indicate that the sponsor rule 900 is default. As shown, the sponsor rule 900 indicates that it should only be used when the current time of day is between 6 AM and 9 AM. It will be apparent that various other criteria may be used such as, for example, consumer locality, day of the week, language, and consumer demographic information as reported by consumer cookies or third party devices.

The sponsor rule 900 also includes a list of sponsors including a sponsor field 930, weight field 940, and URI field 950. The sponsor field 930 may store an identification of a sponsor. The weight field 940 may store a weight value associated with the sponsor based on, for example, the amount the sponsor has paid in advertising fees. The URI field 950 may store a URI that the consumer is to access when the sponsor is selected. As an example, the sponsor rule 900 identifies three sponsors 960, 970, 980 along with associated weights and URIs. Thus, when the sponsor rule 900 is applicable, the lead distribution server may select among Sponsor 1, Sponsor 2, and Sponsor 3 to receive the lead.

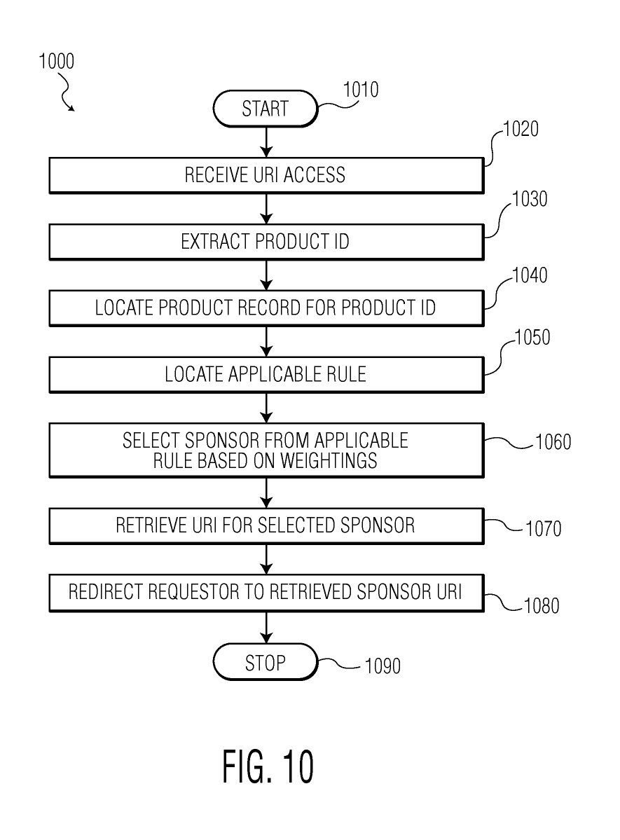

FIG. 10 illustrates an exemplary method 1000 for redirecting a consumer lead. The method 1000 may be performed by a lead distribution server such as, for example, the lead distribution server 150 or lead distribution server 600.

The method 1000 begins in step 1010 and proceeds to step 1020 where the lead distribution server receives a request to access a URI. In step 1030, the lead distribution server extracts a product identifier from the message or URI. For example, in the exemplary system of FIG. 1 and NFC tag contents 300 of FIG. 3, the lead distribution server may extract the product identifier “1264732” from the requested URI. Using the extracted product identifier, the lead distribution server locates a product record in step 1040 and locates an applicable rule in step 1050. Following the example of FIG. 1 and using the product database contents 800 of FIG. 8 and the exemplary rule 900 of FIG. 9, the lead distribution server may determine that the product ID “1264732” corresponds to product record 840, which indicates that sponsor rule “bx123PrimeTime” should first be checked for applicability. Upon evaluating the applicability criteria 920 of the sponsor rule 900 “bx123PrimeTime,” the lead distribution server may determine that the current time falls between 6 AM and 9 AM and that the sponsor rule 900 is therefore applicable.

After locating an applicable sponsor rule, the lead distribution server selects a sponsor from the applicable sponsor rule in step 1060 according to the weightings. The lead distribution server then retrieves the URI for the selected sponsor in step 1070 and redirects the requestor to the retrieved URI in step 1080. Continuing with the example of FIG. 1 and FIG. 9, the lead distribution server may apply a weighted random algorithm by generating a random number between 0 and 3099, based on the sum of the sponsor weights. The generated number may be, for example, 1547 and, as such, may correspond to sponsor 2 because it is greater than the cumulative weight 1000 of sponsor 1 but less than the cumulative weight 3000 of sponsor 2. The lead distribution server may then proceed to redirect the requesting user device 130 to the URI “http://www.sponsor2.com/1621ad3/buy?ref=4ed.” Thus, the user device 130 is directed to access the sponsor 2 website server 162 and to pass the referrer ID “4ed,” thereby indicating that the lead was provided by the lead distribution server 150. After consumer redirection, the method proceeds to end in step 1090.

According to the foregoing, various embodiments enable the generation of leads in an intuitive and user-friendly manner. Additionally, various embodiments enable the sponsored redirection of such leads to various entities interested in such leads. In particular, by providing a product with an NFC tag or other code tag, a user device can be directed to a sponsor website or a lead distribution server that can redirect the user device to a sponsor website. Various additional benefits will be apparent in view of the foregoing.

It should be apparent from the foregoing description that various exemplary embodiments of the invention may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A machine-readable storage medium may include any mechanism for storing information in a form readable by a machine, such as a personal or laptop computer, a server, or other computing device. Thus, a non-transitory machine-readable storage medium excludes transitory signals but may include both volatile and non-volatile memories, including but not limited to read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

1. A consumer product assembly configured to facilitate ordering of a product, the consumer product assembly comprising:
a consumer product to be used by a consumer; and
a code tag that carries a uniform resource identifier (URI) that further includes an identifier for the consumer product,
wherein the code tag is configured to be read by a user device to read the URI and subsequently send a request to a device associated with the URI, and
wherein the URI points to a lead distribution server and is configured to cause the lead distribution server to redirect the user device to a sponsor web page hosted by a device other than the lead distribution server.

2. The consumer product assembly of claim 1, wherein the code tag is attached to the consumer product.

3. The consumer product assembly of claim 1, wherein the code tag is a near field communication (NFC) tag.

4. The consumer product assembly of claim 1, wherein the code tag further stores an instruction to access the URI.

5. The consumer product assembly of claim 1, wherein the consumer product comprises:
a consumable portion; and
a non-consumable portion,
wherein the replacement for the consumer product comprises a replacement consumable portion.

6. The consumer product assembly of claim 5, wherein:
the code tag is affixed to the consumable portion; and
the non-consumable portion is configured to modify the URI stored by the code tag.

7. A method performed by a user device for placing an order for a replacement product, the method comprising:
reading, by a user device, information from a code tag associated with a product,
wherein the information read from the code tag comprises a uniform resource identifier (URI), and
wherein the URI points to a server and further includes an identification of the product;
transmitting an access request to the server based on the URI; and
communicating, in response to transmitting the access request, with a device to place an order for a replacement for the product, wherein the device comprises at least one of the server and an additional server.

8. The method of claim 7, wherein the code tag is a near field communication (NFC) tag.

9. The method of claim 7, wherein the information further includes an instruction to access the URI.

10. The method of claim 7, wherein communicating, in response to transmitting the access request, with a device to place an order for a replacement of the product, wherein the device comprises at least one of the server and an additional server comprises:
receiving, from the device, data for rendering a web page, wherein the web page may be used to place an order for a replacement of the product.

11. The method of claim 7, wherein the server is a lead distribution server and communicating, in response to transmitting the access request, with a device to place an order for a replacement of the product, wherein the device comprises at least one of the server and an additional server comprises:
receiving, from the lead distribution server in response to transmitting the access request, an instruction to access an additional URI that points to a sponsor web server; and
transmitting an additional access request to the sponsor web server based on the additional URI.

12. The method of claim 11, wherein transmitting the additional access request results in ordering the replacement for the product absent subsequent operation of the device by the user.

13. The method of claim 12, further comprising:
modifying at least one of the access request and the additional access request to carry payment information.

14. The method of claim 12, further comprising, prior to transmitting the additional access request:
reading the payment information from an additional code tag associated with a payment instrument.

15. The method of claim 7, further comprising:
modifying the access request to carry at least one of information regarding a user of the product and information regarding recorded use of the product.

16. The method of claim 15, wherein:
the product includes a consumable portion and a non-consumable portion,
the replacement for the product includes a replacement for the consumable portion, and
the method further comprises, prior to modifying the access request to carry at least one of information regarding a user of the product and information regarding recorded use of the product, communicating with the non-consumable portion to obtain the at least one of information regarding a user of the product and information regarding recorded use of the product.

17. A device for placing an order for a replacement product, the device comprising:
a code tag reader configured to read information from a code tag associated with a product;
a network interface for communicating via a network; and
a processor configured to:
receive the information read from the code tag, wherein the information comprises a uniform resource identifier (URI), wherein the URI points to a server and further includes an identification of the product,
transmit, via the network interface, an access request to the server based on the URI, and communicate, via the network interface in response to transmitting the access request, with a device to place an order for a replacement for the product, wherein the device comprises at least one of the server and an additional server.

18. The device of claim 17, wherein the server is a lead distribution server and, in communicating with the device to place an order for the replacement of the product, the processor is configured to:
receive, from the lead distribution server in response to transmitting the access request, an instruction to access an additional URI that points to a sponsor web server; and transmit an additional access request to the sponsor web server based on the additional URI.

19. The device of claim 18, wherein transmitting the additional access request results in ordering the replacement for the product absent subsequent operation of the device by the user.

20. The device of claim 18, wherein the processor is further configured to modify at least one of the access request and the additional access request to carry payment information.

21-40. (canceled)
